(19) United States
(12) Patent Application Publication
(10) Pub. No.: US 2021/0357017 A1
(43) Pub. Date: Nov. 18, 2021

(54) MOTION MATCHING IN VIRTUAL ENVIRONMENTS

(71) Applicant: HEWLETT-PACKARD DEVELOPMENT COMPANY, L.P., Spring, TX (US)

(72) Inventors: Ian N. Robinson, Palo Alto, CA (US); Mary G. Baker, Palo Alto, CA (US)

(21) Appl. No.: 16/606,094

(22) PCT Filed: Jul. 10, 2018
(86) PCT No.: PCT/US2018/041517

§ 371 Date: Oct. 17, 2019

(51) Int. Cl. G06F 3/01; G02B 27/01; G06F 1/16

(52) U.S. Cl. CPC G06F 3/011; G02B 27/0179; G02B 2027/0187; G06F 1/1694; G02B 27/017

(57) ABSTRACT

An example system includes a tracker device inertial data determination portion to determine inertial data of a tracker device, a tracker device inertial data broadcast portion to broadcast a signal indicative of the inertial data of the tracker device, and a matching device coupling portion to, in response to receiving a signal from a user device indicative of motion matching of the user device with the tracker device, couple the user device with a virtual environment display portion associated with the tracker device.

### BACKGROUND

Virtual environments, such as virtual reality and augmented reality, allow users to view a virtual environment with virtualized components. The virtualized components may be presented in a virtual environment to the user through a head-mounted display. In some examples, the user may manipulate various virtualized components. For example, a user may control the movement of a virtualized vehicle in a virtual-reality game.

### BRIEF DESCRIPTION OF THE DRAWINGS

For a more complete understanding of various examples, reference is now made to the following description taken in connection with the accompanying drawings in which:

FIG. 1 illustrates an example system for motion matching in a virtual environment;

FIG. 2 illustrates another example system for motion matching in a virtual environment;

FIG. 3 illustrates a user with an example virtualization system;

FIG. 4 illustrates an example virtual environment presented to the user in the example of FIG. 3;

FIG. 5 is a flow chart illustrating an example method for motion matching of components in a virtual environment;

FIG. 6 is a flow chart illustrating an example method for a user device to motion match with a virtualization system; and

FIG. 7 illustrates a block diagram of an example system with a computer-readable storage medium including instructions executable by a processor for motion matching of a user device.

### DETAILED DESCRIPTION

Virtual environments can be displayed in a virtual headset. While a user is wearing the headset, it is difficult for a user to interact with other user devices, such as a mobile device, for example. A user generally exits the virtual environment by, for example, removing the headset to access the mobile device. For example, if the user receives an email on his mobile device, the user removes the headset to view the email on the mobile device.

Various examples described herein relate to virtual environments. In various examples, a user device may be coupled to the virtualization system and presented in the virtual environment. The virtualization system includes tracker devices that are associated with the virtualization system and may be worn by a user, for example, on a hand. The tracker devices may include inertial measurement units to measure, or determine, inertial data for the tracker devices. The virtualization system can broadcast the inertial data of the tracker devices. The broadcast data may be received by a user device, such as a mobile device or any of a variety of other devices. In this regard, various mobile devices include motion tracking systems to, for example, support changing screen orientation or monitoring physical activity of a user for a health application. The user device may compare the inertial data of the tracker devices with similar data of the user device. Based on this comparison, the user device may determine motion matching between the user device and a tracker device. For example, if the user is holding a mobile device in his hand, the inertial data of the mobile device may match the inertial data of the tracker device worn on that hand. The user device may then send an indicator to the virtualization system indicating the motion matching, and the virtualization system may couple the user device and present virtualization of the user device in the virtual environment. In various examples, the broadcasting of the inertial data of the tracker device eliminates the need for various user devices to continuously transmit similar data. Thus, user devices can conserve power (e.g., battery power) by merely responding to detected broadcast signals when motion matching is determined.

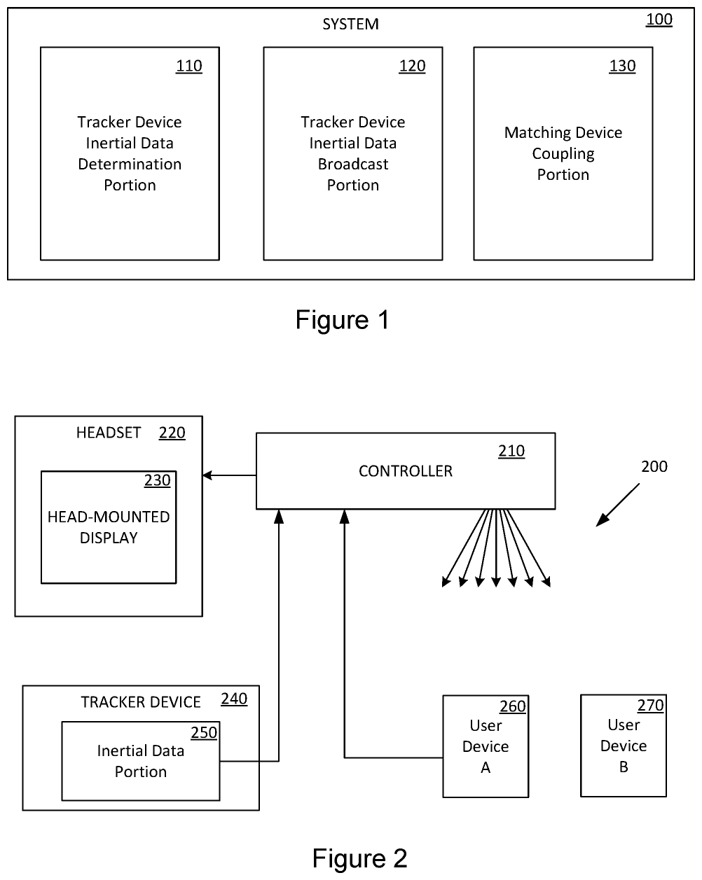

Referring now to FIG. 1, an example system 100 for motion matching in a virtual environment is illustrated. The example system 100 includes a tracker device inertial data determination portion 110 to determine inertial data of a tracker device (not shown in FIG. 1). In various examples, the tracker device may be a wearable device that is worn by a user and may be used to detect movement by the user. In one example, as described below, the tracker device is worn on a hand of the user and may be used to detect movements or gestures made by a user.

In various examples, the tracker device inertial data determination portion 110 determines the inertial data of the tracker device by receiving information from the tracker device. For example, the tracker device may include an inertial measurement unit (IMU) and may transmit information from the IMU to the tracker device inertial data determination portion 110. The information from the IMU may include, or be used to determine, inertial data such as the motion of the tracker device, and the direction of gravity. Further, additional information, such as change in position or orientation, may be derived or calculated from the information from the IMU. In various examples, an IMU can measure acceleration, via accelerometers, and may be able to provide velocity (by integrating acceleration over a time interval) and a change in position (by integrating the velocity over the time interval). In some examples, the tracker device inertial data determination portion 110 may include other tracking capability, such as optical tracking systems, to provide direct measurements of position and/or orientation.

In various examples, the tracker device is either a part of or coupled to a virtualization system. In this regard, the tracker device can communicate with the tracker device inertial data determination portion 110 wirelessly via any of a variety of wireless protocols.

The example system 100 of FIG. 1 further includes a tracker device inertial data broadcast portion 120 to broadcast a signal indicative of the inertial data of the tracker device. In this regard, the inertial data may be transmitted by the tracker device inertial data broadcast portion 120 for receipt by user devices within a predetermined distance. In one example, the inertial data is broadcast in a short range, such as less than 100 feet.

The example system 100 of FIG. 1 further includes a matching device coupling portion 130. The matching device coupling portion 130 is provided to couple a user device (not shown in FIG. 1) with a virtual environment display portion (not shown in FIG. 1), such as a head-mounted display, in response to receiving a signal from the user device indicating motion matching between the user device and the tracker device. In this regard, the inertial data broadcast by the tracker device inertial data broadcast portion 120 may be received by the user device, and the user device may compare the broadcast inertial data with corresponding inertial data of the user device. Based on the comparison, the user device may determine that the user device and the tracker device have substantially similar inertial data. In this regard, motion matching may include matching movement and orientation with respect to gravity of the user device and the tracker device.

Referring now to FIG. 2, another example system 200 for motion matching in a virtual environment is illustrated. The example system 200 includes a controller 210 which may be implemented in various examples as hardware, software, firmware or a combination thereof. In some examples, the controller 210 may include the functionality of the tracker device inertial data determination portion 110, the tracker device inertial data broadcast portion 120, and the matching device coupling portion 130 of the example system 100 described above with reference to FIG. 1.

Further, the example system 200 of FIG. 2 includes a headset 220 communicatively coupled to the controller 210. In this regard, the communication between the headset 220 and the controller 210 may be through a wireless or a wired connection. In one example, the controller 210 is positioned within the headset 220.

The headset 220 includes a head-mounted display 230. In various examples, the head-mounted display 230 may include a screen or a screen portion for each eye. In one example, the head-mounted display 230 includes a screen that includes a left-eye portion and a right-eye portion corresponding to each eye of the user. The head-mounted display 230 may display a virtual environment to the user in accordance with instructions from the controller 210.

In various examples, the controller 210 may include a virtual environment display portion. The virtual environment display portion is provided to generate a virtualized environment to be displayed on the head-mounted display 230. As used herein, virtualized environment includes virtual reality, as well as augmented reality in which a virtual environment and the physical environment are displayed together. In some examples of augmented reality systems, the user is provided with a direct view of the physical environment, and virtual elements are overlaid onto the physical environment via, for example, a half-silvered mirror. In this regard, virtual elements may augment the physical environment of the user.

In one example, the virtual environment display portion generates two corresponding images, one for the left-eye portion of the head-mounted display 230 and another for the right-eye portion of the head-mounted display 230.

The example system 200 of FIG. 2 further includes a tracker device 240. As noted above, the tracker device 240 may be a wearable device worn by the user of system 200. Thus, in various examples, the user may wear the headset 220 and the tracker device 240. In one example, the tracker device 240 is worn on a hand of the user.

The tracker device 240 includes an inertial data portion 250. In one example, the inertial data portion 250 includes an inertial measurement unit (IMU) or other such component to measure or detect an inertial parameter, such as acceleration in each of the three spatial axes of the tracker device 240. In various examples, the inertial data portion 250 includes accelerometers, gyroscopes, magnetometers or a combination thereof. The tracker device 240 is coupled to the controller 210 and transmits inertial data from the inertial data portion 250 to the controller 210. In this regard, the inertial data may be transmitted at regular intervals or upon any change in the inertial data.

In the example illustrated in FIG. 2, the example system 200 includes user devices 260, 270. The user devices 260, 270 may be any of a variety of devices including, but not limited to, mobile phones, smart watches, laptops, desktops, tablets or the like. In various examples, the user devices 260, 270 include an application or the like to associate the user devices 260, 270 with the controller 210.

In one example, the controller 210 is to receive inertial data from the inertial data portion 250 of the tracker device 240. The controller 210 then broadcasts inertial data for the tracker device 240 for receipt by the user devices 260, 270. In one example, the broadcast of the inertial data may be broadcast for receipt by user devices 260, 270 that are nearby, such as within the same room as the controller 210. Each user device 260, 270 may then determine whether the inertial data of the tracker device 240 indicates motion matching with the user device 260, 270. In this regard, each user device 260, 270 may compare the inertial data of the tracker device 240 with similar inertial data of the user device 260, 270.

In various example, the comparison performed by the user device 260, 270 includes comparing data from the inertial data portion 250 (e.g., IMU) of the tracker device 240 with inertial data from an IMU of the user device 260, 270. In this regard, the user device 260, 270 may evaluate the change in magnitude within certain time intervals. In various examples, the time intervals are sufficiently large to allow for possible communication delays or other delays. The comparison process may include multiple comparisons involving different sets of data from the inertial data portion 250 of the tracker device 240, for example. If a correlation is determined between the inertial data of the tracker device 240 and the inertial data of the user device 260, 270, motion matching may be indicated.

If the comparison indicates motion matching, the user device 260, 270 may transmit a signal to the controller 210. In the example of FIG. 2, the User Device A 260 is illustrated as a motion matching device, while the User Device B 270 is indicated as not motion matching. For example, the tracker device 240 may be a wearable device worn on the hand of a user, and the User Device A 260 may be a smart phone held in the same hand. Thus, motion of the User Device A 260 matches the motion of the tracker device 240. The User Device A 260 transmits a signal to the controller 210 indicating motion matching and, in response, the controller 210 couples the User Device A 260 with the controller 210, as indicated by the connector illustrated in FIG. 2. Coupling of the User Device A 260 with the controller 210 may include presenting a virtualization of the User Device A 260 in a virtual environment presented in the head-mounted display 230.

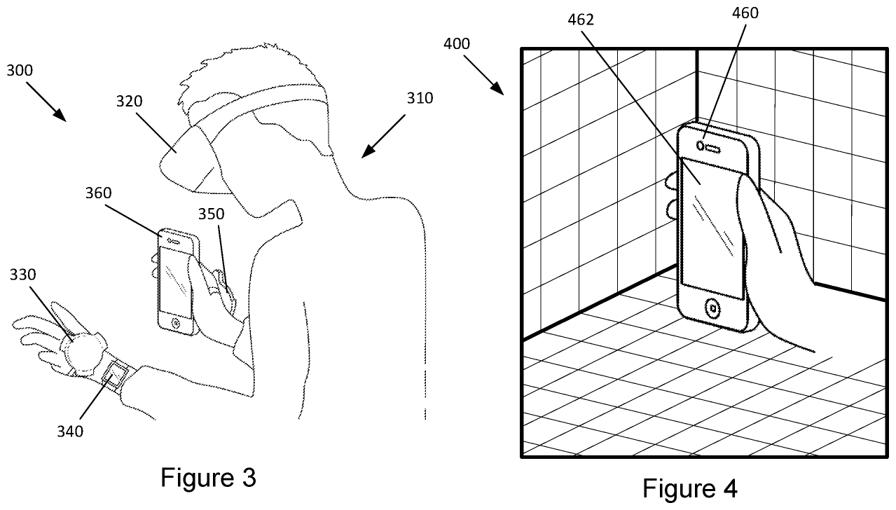

Referring now to FIG. 3, an arrangement with a user with an example virtualization system is illustrated. In the example arrangement 300 of FIG. 3, the user 310 is wearing a headset 320 which includes a head-mounted display. The user 310 is presented with a virtual environment in the head-mounted display of the headset 320. The user 310 is shown wearing a first tracker device 330 on his left hand and wearing a smart watch 340 on the same hand. Further, the user 310 is shown wearing a second tracker device 350 on his right hand and holding a smart phone 360 in the same hand. As described with reference to FIGS. 1 and 2 above, the tracker devices 330, 350 may include IMU's and may provide the IMU data to a controller, which may be provide within the headset 320. The IMU data may then be broadcast for receipt by devices such as the smart watch 340 and the smart phone 360, each of which may determine whether motion of the user device 340, 360 matches that of one of the tracker devices 330, 350. In the example of FIG. 3, the smart watch 340 has motion matching with the first tracker device 330, and the smart phone 360 has motion matching with the second tracker device 350.

The user devices 340, 360 transmit a signal indicating motion matching to the controller and may then be coupled to the controller. The controller may then present a virtualization of the motion matching user device 340, 360 in a virtual environment presented to the user in the headset 320, an example of which is illustrated in FIG. 4.

FIG. 4 illustrates a portion of an example virtual environment 400 presented to the user 310 in the example of FIG. 3 through a head-mounted display in the headset 320. The example virtualized environment 400 may be generated and viewed in a virtualization system. In this regard, the example virtualized environment 400 may be generated for viewing using a head-mounted display, such as a head-mounted display in the headset 320 illustrated in FIG. 3. As noted above, the example virtualized environment 400 may be a virtual-reality (VR) environment or an augmented reality (AR) environment which includes virtual components combined with the physical environment.

In the example virtual environment 400 of FIG. 4, the user is presented with a virtualization 460 of the smart phone 360. The motion matching of the smart phone 360 may be used to present a corresponding position and/or orientation of the smart phone 360 in the virtualization 460 of the smart phone 360. For example, as part of the motion matching calculation the smart phone 360 can determine its orientation with respect to the orientation of the tracker device. This information can be transmitted back to the controller by the smart phone 360 as part of the motion matching indication.

In some examples, the coupling of the smart phone 360 with the controller includes sharing of content displayed on a display screen of the smart phone 360. The controller may then present the content on a virtual display screen 462 of the virtualization 460 of the smart phone 360. Thus, a user may access content, such as an email or a text message, on the smart phone 360 while viewing the virtualization 460 of the smart phone 360 in the virtual environment 400.

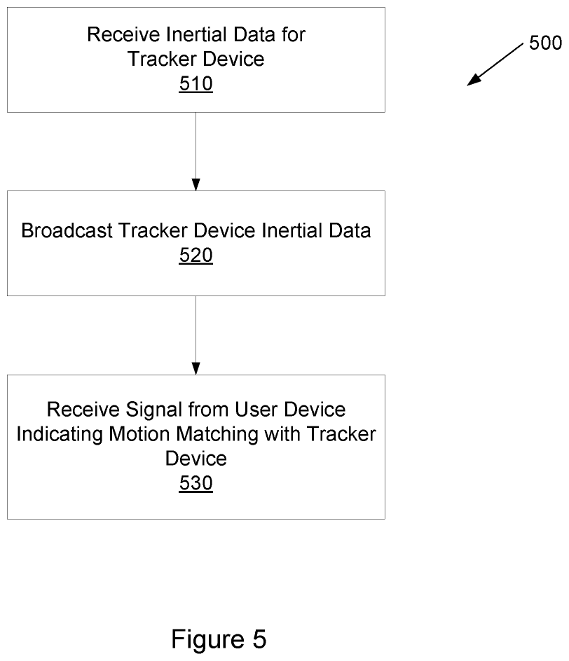

Referring now to FIG. 5, a flow chart illustrates an example method 500 for motion matching of components in a virtual environment. The example method 500 may be performed by a controller of a virtualization system used to present a virtual reality or augmented reality environment to a user. The example method 500 includes receiving inertial data for a tracker device (block 510). As described above with reference to FIG. 2, the controller 210 may receive inertial data from an inertial data portion 250 (e.g., IMU) of the tracker device 240. As illustrated in the example of FIG. 3, tracker device 330, 350 may be used to track position, orientation or movement of a corresponding hand of the user.

The example method 500 further includes broadcasting the inertial data for the tracker device (block 520). As noted above, the inertial data may be broadcast for receipt by various user devices in a region.

At block 530 of the example method 500, the controller may receive a signal from a user device indicating motion matching of the user device with the tracker device. In various examples, the signal from the user device is in response to the broadcast of the inertial data for the tracker device by the controller.

In various examples, upon receiving indication of motion matching of a user device, the controller may couple the user device with the controller and present a virtualization of the user device in a virtual environment associated with the tracker device. In this regard, the coupling of the device may allow the controller to identify the type of device (e.g., smart phone or smart watch) and other details associated with the user device (e.g., size). This information may be used to present the virtualization of the user device.

In one example, the user device may transmit a motion matching status change indication when, for example, motion matching is terminated. For example, the user may set down a smart phone while a virtualization of the smart phone is being presented to the user. At this point, the motion matching may be halted. The virtualization of the smart phone may continue in a static manner until the smart phone transmits a status change with respect to motion matching. The status change may result in the removal of the virtualization of the smart phone from the virtual environment presented to the user.

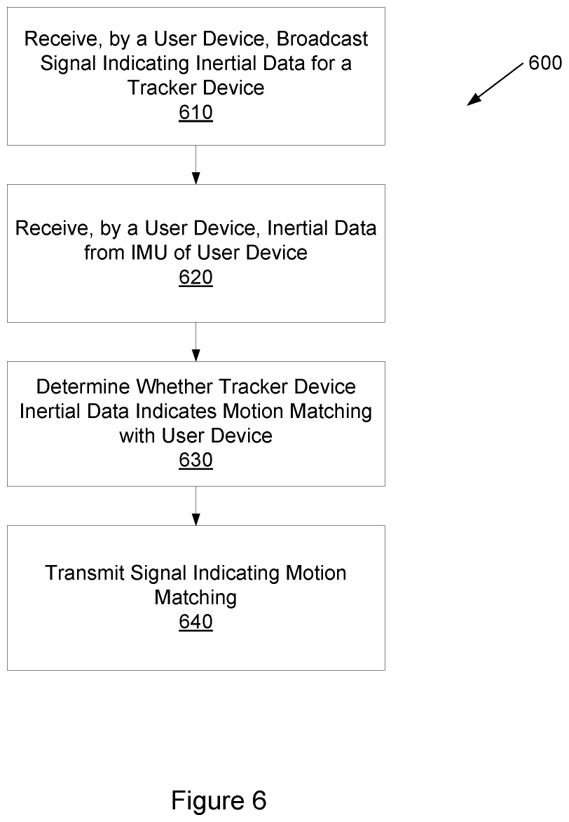

FIG. 6 is a flow chart illustrating an example method 600 for a user device to motion match with a virtualization system. The example method 600 may be performed by the user device and may correspond to the example method 500 performed by a controller of a virtualization system. In this regard, the example method 600 includes receiving, by a user device, a broadcast signal with inertial data for a tracker device (block 610). The broadcast signal received by the user device may be, or may correspond to, the broadcast by the controller of the inertial data of the tracker device, as illustrated at block 520 of the example method 500 of FIG. 5.

The user device, or a controller thereof, may receive inertial data of the user device from an inertial measurement unit (IMU) of the user device (block 620). As noted above, various user devices may include accelerometers or other components to measure, or allow calculation of, various inertial parameters.

The example method 600 of FIG. 6 further includes determining whether the inertial data of the tracker device indicates motion matching with the user device (block 630). In this regard, the user device may compare the inertial data of the tracker device with similar or corresponding inertial data of the user device. As noted above, inertial data may include movement and orientation data of the tracker device and the user device.

Upon determination of motion matching, the user device transmits a signal to the controller indicating the motion matching (block 640). The signal may include an identification of the user device, and the matching tracker device, to the controller and allow the controller to couple with the user device.

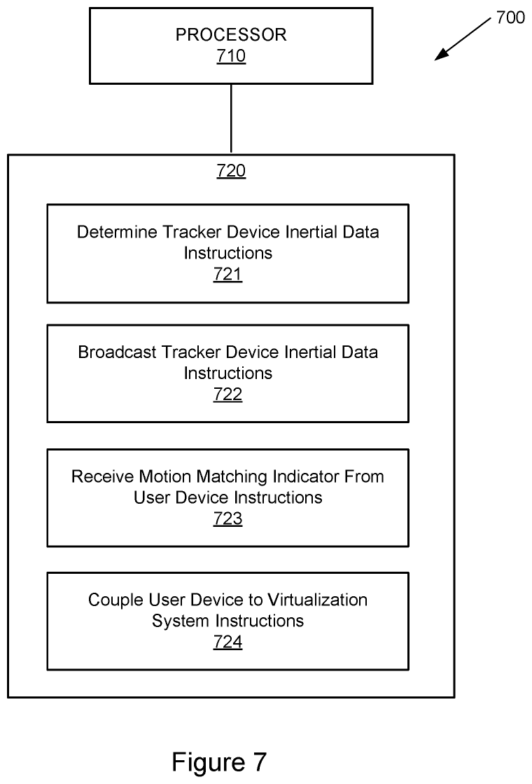

FIG. 7 illustrates a block diagram of an example system with a computer-readable storage medium including instructions executable by a processor for motion matching of a user device.

Referring now to FIG. 7, a block diagram of an example system 700 is illustrated with a computer-readable storage medium including instructions executable by a processor for forming a virtual display monitor. The system 700 includes a processor 710 and a non-transitory computer-readable storage medium 720. The computer-readable storage medium 720 includes example instructions 721-724 executable by the processor 710 to perform various functionalities described herein. In various examples, the non-transitory computer-readable storage medium 720 may be any of a variety of storage devices including, but not limited to, a random access memory (RAM) a dynamic RAM (DRAM), static RAM (SRAM), flash memory, read-only memory (ROM), programmable ROM (PROM), electrically erasable PROM (EEPROM), or the like. In various examples, the processor 710 may be a general purpose processor, special purpose logic, or the like.

The example instructions include determine tracker device inertial data for a tracker device instructions 721. As noted above, determining of the inertial data of the tracker device may include receiving the inertial data from the tracker device. The inertial data may be based on an inertial measurement unit (IMU) or similar component in the tracker device.

The example instructions further include broadcast tracker device inertial data instructions 722. As described above, a controller of a virtualization system may broadcast the inertial data for a tracker device for receipt by various user devices.

The example instructions further include receive motion matching indicator from a user device instructions 723. As noted above, the indicator received from the user device may be indicative of motion matching of the user device and the tracker device. The motion matching may include matching of movement and orientation.

The example instructions further include couple the user device to a virtualization system instructions 724. As described above, a motion matching user device may be coupled to a controller associated with the tracker device with which the user device is motion matching.

In some examples, a virtualization of the user device may then be presented in a virtual environment presented to the user. For example, the virtualization of the user device and the virtual environment may be presented to the user in a head-mounted display.

Thus, in various examples, a user device may be determined to be motion matching with a tracking device while conserving battery power. By broadcasting the inertial data of the tracker device, user devices are not required to expend battery power by transmitting their own inertial data. The user devices can compare the broadcast inertial data with their own inertial data and transmit a signal if motion matching is determined.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A system, comprising:
a tracker device inertial data determination portion to determine inertial data of a tracker device;
a tracker device inertial data broadcast portion to broadcast a signal indicative of the inertial data of the tracker device; and
a matching device coupling portion to, in response to receiving a signal from a user device indicative of motion matching of the user device with the tracker device, couple the user device with a virtual environment display portion associated with the tracker device.

2. The system of claim 1, wherein the tracker device inertial data determination portion is to determine the inertial data of the tracker device by receiving the inertial data from an inertial measurement unit of the tracker device.

3. The system of claim 1, wherein the inertial data includes at least one of orientation information or movement information.

4. The system of claim 1, wherein the virtual environment display portion includes a headset with a head-mounted display to present a virtual environment to the user.

5. The system of claim 4, wherein, the virtual environment presented to the user includes a virtualization of the user device indicated as motion matching with the tracker device.

6. The system of claim 1, wherein the user device is a mobile device with a display screen.

7. The system of claim 5, wherein the virtual display portion is to present content on a display screen of the virtualization of the user device in the virtual environment.

8. A method, comprising:
receiving inertial data for a tracker device;
broadcast the inertial data for the tracker device; and
receive a signal from a user device, in response to the broadcast of the inertial data for the tracker device, the signal indicating motion matching of the user device with the tracker device.

9. The method of claim 8, further comprising:
presenting a virtualization of the user device in a virtual environment associated with the tracker device.

10. The method of claim 9, wherein the virtualization of the user device in the virtual environment is presented on a head-mounted display.

11. The method of claim 8, wherein the inertial data includes at least one of orientation information or movement information.

12. A non-transitory computer-readable storage medium encoded with instructions executable by a processor of a computing system, the computer-readable storage medium comprising instructions to:
determine inertial data for a tracker device;
broadcast the inertial data for the tracker device;
receive an indicator from a user device, the indicator being indicative of matching of motion of the user device and the tracker device; and
couple the user device to a virtualization portion associated with the tracker device.

13. The non-transitory computer-readable storage medium of claim 12, further comprising instructions to:
present a virtualization of the user device in a virtual environment associated with the tracker device.

14. The non-transitory computer-readable storage medium of claim 13, wherein the virtualization of the user device in the virtual environment is presented on a head-mounted display.

15. The non-transitory computer-readable storage medium of claim 12, wherein the inertial data includes at least one of orientation information or movement information.
